(19) United States
(12) Patent Application Publication
(10) Pub. No.: US 2016/0026926 A1
(43) Pub. Date: Jan. 28, 2016

(54) CLOTHING MATCHING SYSTEM AND METHOD

(71) Applicants: Singapore University of Technology and Design, Singapore (SG); Hong Kong University of Science and Technology, Kowloon (HK); University of California, Los Angeles, Los Angeles, CA (US)

(72) Inventors: Sai-Kit Yeung, Singapore (SG); Tony Chan, Kowloon (HK); Lap-Fai Yu, Los Angeles, CA (US); Demetri Terzopoulos, Los Angeles, CA (US)

(73) Assignees: Singapore University of Technology and Design, Singapore (SG); Hong Kong University of Science and Technology, Kowloon (HK); University of California, Los Angeles, Los Angeles, CA (US)

(21) Appl. No.: 14/442,362

(22) PCT Filed: Nov. 12, 2013
(86) PCT No.: PCT/SG2013/000482

§ 371 Date: May 12, 2015

Related U.S. Application Data
(60) Provisional application No. 61/725,073, filed on Nov. 12, 2012.

(51) Int. Cl. G06N 7/00; G06N 99/00

(52) U.S. Cl. CPC G06N 7/005; G06N 99/005

(57) ABSTRACT

The invention provides a clothing matching system and a method for generating at least an outfit suggestion comprising the steps of determining a colour classification of a user, providing a plurality of articles of clothing, selecting a dress code based on the user preference and generating at least one outfit suggestion based on the colour classification of the user, the plurality of clothing items and the selected dress code.

### RELATED APPLICATION

This application claims the benefit of U.S. Provisional Application No. 61/725,073, filed Nov. 12, 2012, the contents of which are incorporated herein by reference.

### FIELD

The present invention relates to a clothing matching system and method.

### BACKGROUND

Each day, a person will often ask the simple question: How should I dress today? His or her wardrobe contains various kinds of clothes, such as dress shirts, dress pants, jeans, sweaters, suits, and different types of shoes. What combination of clothing will be most appropriate for the day's activities, thereby making him or her most visually appealing? Perhaps multiple suggestions that best coordinate with the new tie received from someone as a birthday gift. The outfit selection problem also occurs in computer graphics modelling, especially in movie and game production: How should one appropriately dress a large number of human characters with an eye to functionality while avoiding visual awkwardness and repetitiveness? The manual specification of clothing is obviously tedious and it may be prohibitive on a large scale.

The problem of selecting appropriate subsets of clothing items from a wardrobe can be addressed formally as a combinatorial optimization problem. A suitable outfit requires jointly combining a variety of clothing items to satisfy functional and certain visual criteria. For example, a pair of sandals with dress pants is generally not worn to the office, nor a red dress shirt with a green suit for a business meeting. In addition, to put a wardrobe into full use, one would like to have as many good solutions as possible, so that one can exhibit sartorial variety. A similar, but much larger-scale problem comes up with regard to online boutique websites, where shoppers can select among many clothing items. Usually it is not difficult for a shopper to locate a desired clothing item; the nontrivial question is how this clothing item should be matched in terms of style and colour with other clothing items from the same or different shops or from one's wardrobe at home.

There is no single universal rule that satisfies both the relevant functional and visual criteria. People generally categorize outfits into dress codes, which represent different functionalities. These can range from strictly regulated ones such as White Tie, suitable for formal events, to relatively unrestricted ones such as Casual, suitable for many everyday activities. Without restriction, one can define a particular clothing requirement for an event and consider it a dress code. Different religions, societies, and cultural practices adhere to different dress codes; for example, in some formal occasions, Scottish men wear a kilt, a form of dress not commonly worn by men elsewhere. The visual criteria involve numerous factors, from human body attributes such as skin colour, eye colour, hair colour, and body shape, which are model-specific, to aspects of the clothing items such as the clothing colour, cutting, style, and fabric texture. The rules vary across national and cultural boundaries and historic timelines. Even when one has satisfied all the applicable rules, whether one is dressed in a visually pleasing manner is still a rather subjective question.

In tackling the clothes matching problem, functional and visual criteria are enforced through the two most important factors—dress code and colour. While colour is an obvious visual factor, to a certain extent it is also related to functionality, which in turn depends on culture. For example, people in China usually dress in red for festivals and in white for funerals. On the other hand, the dress code is a broader guideline that pertains more to the combination of clothing items. Some dress codes also have strict requirement for the colours of particular items, but how different colours coordinate is not their main concern.

In the area of computer graphics, modelling, animating, and rendering visually realistic clothing has been an area of interest for decades and it has received much attention in recent years in movies and games especially for dressing large numbers of human characters. Researchers have been putting significant effort into the realistic modelling and/or animation of clothing, and their efforts have enabled computer animated clothing to blend seamlessly with the clothing worn by real actors. Tools are now available to help artists interactively design virtual garments, which is adequate for highly-detailed, small scale production, e.g., for motion pictures. However, manual approaches become too tedious on a large scale, such as when there is a need to clothe numerous virtual humans in a virtual city. Research on automatic outfit synthesis in computer graphics is not available; i.e., given a set of clothing items and a human body model, automatically suggest a clothing combination for a general or particular scenario.

In the area of human modelling, human characters are an important aspect of creating virtual worlds. While realistic human animation and rendering may be relevant, variety in human appearance may also be relevant when considering a large group of people. For the most part, existing human modelling software requires substantial manual intervention. However, prior art research has proposed approaches to mass-produce various characters by automatically modifying the texture, colour, and geometry of different body parts in order to create crowds that exhibit some natural variation. However, the goal of prior approaches is to enhance the realism of the crowd as a whole, rather than specific concern as to whether any individual in the crowd is dressed properly or in a visually pleasing manner. The lack of a fast, highly automated approach to this problem limits variation in the style of human characters, leading, in particular, to repetitive sartorial patterns that greatly reduce realism.

### SUMMARY

In a first specific expression of the invention there is provided a computer-implemented method for generating an outfit suggestion, comprising:
providing wardrobe data representing a plurality of clothing items;
providing probabilistic model data representing a probabilistic model, the probabilistic model comprising probabilities of the clothing items being matched with each other conditional on one or more parameters;
receiving user input relating to at least one of the one or more parameters; and
performing an optimization to generate one or more optimal or near-optimal outfit suggestions from the wardrobe data based on the probabilistic model data and the user input.

Embodiments may be implemented according to any of claims 2 to 23.

### BRIEF DESCRIPTION OF THE DRAWINGS

Exemplary, non-limiting embodiments of the present application will now be described with reference to the accompanying figures in which:

FIG. 1 is an overview of a method for generating an outfit suggestion;

FIG. 2 shows example images of typical dress codes;

FIG. 3 an overview of an alternative method for generating an outfit suggestion;

FIG. 4(a) shows a table representing distributions of clothing items combinations with a Bayesian network;

FIG. 4(b) shows a part of an example Bayesian network for men, trained using labelled fashion images;

FIG. 5 shows a complete Bayesian network for men;

FIG. 6 shows a complete Bayesian network for women;

FIG. 7 shows example images of with corresponding labelled data used for Bayesian network training;

FIG. 8 is a table showing example probabilistic queries supported by Bayesian networks for women;

FIG. 9(a) is a table showing example classification guidelines for four-season body colour tone;

FIG. 9(b) shows examples fashion images and its corresponding 5-colour palette;

FIG. 10 shows the results generated where specific clothing items are being fixed;

FIG. 11 shows the results generated from the effects of omitting individual cost terms;

FIG. 12 shows the results generated with two different colour palettes;

FIG. 13 shows the results generated with multiple outfit recommendations;

FIG. 14 shows outfit suggestions generated from a random initial configuration for dress code Business from the left to being iteratively updated until the outfit converges to the desired clothing item combination with coordinated colour;

FIG. 15 shows the outfit synthesis results for the models, associated items and the 5-colour palette;

FIGS. 16 (a) to (d) show close up views of populated virtual scenes with and without outfit consideration;

FIG. 17 shows a virtual beach scene which is heavily populated and dressed according to the Sportswear and Casual dress code;

FIG. 18 shows example images of Experiment 2 of the perceptual study;

FIG. 19(a) shows the results of the recognition rates of Experiment 1;

FIG. 19(b) shows, the results of the user's preference of Experiment 2;

FIG. 20(a) shows the results of t-tests against chance for Experiment 1 and FIG. 20(b) Experiment 2; and

FIG. 21 is a block diagram of a system for generating an outfit suggestion.

### DETAILED DESCRIPTION

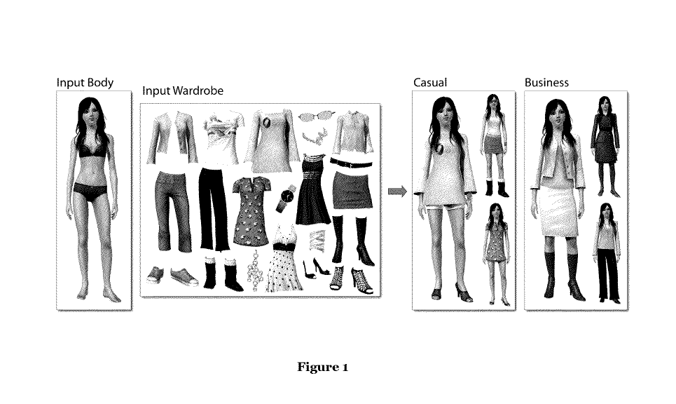

FIG. 1 illustrates an embodiment showing a system and a method for generating an outfit suggestion with functional criteria (for example, body having a specific hair colour, eye colour, and skin colour) and visual criteria (for example, clothing items having specified colours) as input to generate at least one outfit suggestion. A user inputs the functional criteria, visual criteria and based on the set of clothing items provided, the system generates an outfit suggestion to the user. Embodiments may be utilized in online shopping or boutique websites, smartphone mobile applications or desktop applications as a styling guide for personal use, or as part of a character modelling engine for games/virtual world applications.

### Colour in Clothing

Recently, techniques for combining colours in a scene to make it look, say, “harmonious” or “peaceful” have been gaining interest. Colour coordination is a core consideration in clothes matching. Fashion and make-up professionals usually regard colour coordination as person-specific, mostly dependent on the person's intrinsic colour tones, in particular, the skin, eye, and hair colours. A basic approach is to first classify individuals as suited to a ‘warm’ or ‘cool’ colour palette, from which they should choose the colours for their clothes. As there is no definitive classification rule, subjective evaluation is usually performed, and a common test is to have observers evaluate whether the individual looks best wearing gold or silver accessories, respectively. There are other variations of classification which are more subtle and abstract—e.g., in accordance with the season, or according to “light/deep/clear/soft”. However, the basic principle is still the same—suggesting a colour palette for clothing items based on the classification result.

Given a specific dress code favouring various combinations of clothing items and a human body, embodiments may optimize the colour compatibility between the human body and the suggested items in order to realize both the functional and visual criteria. Four of the most common dress codes Sportswear, Casual, Business-Casual, and Business, which cover the main functionalities of daily life in much of the world, are covered. In a preferred embodiment, these dress codes are encoded within a probabilistic framework, via a Bayesian network. The Bayesian network is trained on real image data and it associates any particular clothing item combination with an observed probability distribution under any specific dress code. Additional dress codes and other matching criteria can be trained and included in the same manner. As is common practice in the fashion industry, the colour type of the human subject can be classified as ‘warm’ or ‘cool’ based on his or her skin, hair, and eye colours. This is automatically accomplished by a classifier that is pre-trained on a database of images of people. After assigning the user colour type, the system and method will suggest a preferable colour palette for the subject and this colour palette will serve as a soft constraint during the optimization, which automatically searches for clothing items guided by the dress code while satisfying colour compatibility criteria subject to the suggested colour palette.

### Dress Codes

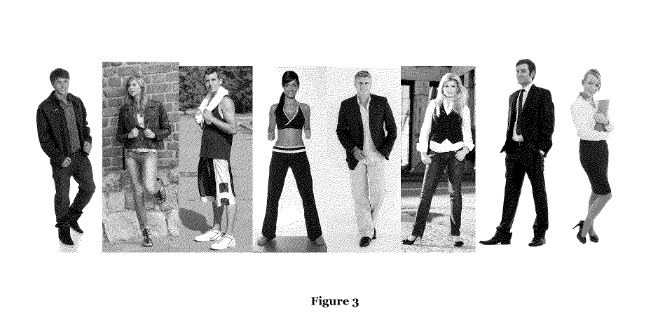

A dress code is a set of rules governing what garments may be worn together and in what setting. Such rules are commonly agreed upon among people, usually dependent on events and occasions. Common dress codes nowadays include Sportswear, Casual, Business-Casual, Business, and Formal. FIG. 3 shows typical example images of these dress codes. Some of the aforementioned dress codes also constrain the colour of the items; for example, Business clothing tends to be darker, while there is not much restriction in Casual or Sportswear. Pattern, fabric weight, and texture are also relevant to the dress code. The dress code is important in governing the functionality of the clothing. However, the main objective of a dress code is to convey a message through the combination of various clothing items. For example, dressing without a tie for a job interview will convey a less formal and more relaxed impression, while donning a suit, dress shirt, and tie to the beach will create an unusual scene. Without a strict definition, the perception of some dress codes can be ambiguous and personal; e.g., some Business Casual outfits may be regarded as Business or Casual.

### Data Driven Approaches

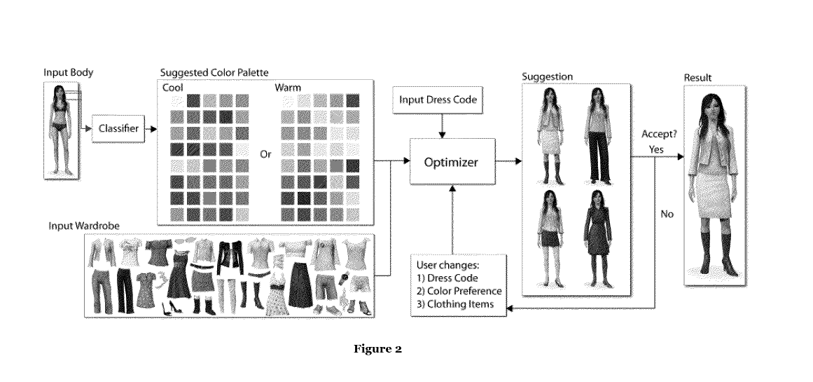

FIG. 2 shows an overview of an embodiment of the method for generating an outfit suggestion. The inputs comprise a human body model, body colour attributes, an input dress code, and a predefined wardrobe. The human body model may be input in a standard 3D file format such as OBJ, and the input data may comprise a pre-generated model produced by 3D rendering software such as Poser of Smith Micro Software (poser.smithmicro.com), or Blender (www.blender.org). Alternatively, the human body model may be generated by a colour 3D scan of a user, for example by using a specific-purpose colour 3D scanning apparatus or by using a motion sensing device such as Kinect of Microsoft Corporation, or Xtion of ASUSTeK Computer Inc., in conjunction with suitable reconstruction software such as Skanect of ManCTL (skanect.manctl.com).

The method generates one or more optimized outfit suggestions according to cost terms defined by the dress code, the suggested colour palette, and colour compatibility. The method can also respond to a user's change of style such as colour preference, or the specification of particular clothing items.

There are two pre-processing steps before the optimization process—encoding the clothing relationship and classifying the colour tone of the subject body. The relationships among different clothing items must be quantified so that compatible costs can be defined among them; for example, what should or should not be worn based on the selected dress code and some already selected clothing items. As discussed, the dress code involves various factors and can change from time to time. For example, a dress shirt usually goes with dress shoes if dress pants are worn, but there could be more flexibility if jeans are worn.

An expedient way to generate outfit variety is to randomly select among predefined rules to combine clothing items. However, the question of how to define the rules, which is critical to synthesis quality, is susceptible to subjective bias. It is difficult to consider all possible combinations, and the rules quickly become intractable to maintain as the types of clothing items grow. Restricting to a small subset of possible outfits may avoid awkward synthesis, but it will result in limited variety and common artefacts such as “repeated” characters that are noticeable in virtual scenes. The lack of conditional query support has also prohibited the use of such approaches in practical scenarios (e.g., shopping websites).

One possibility to encoding various relationships and defining compatible costs between clothing items is to adopt a data-driven approach based on observational data. Data driven approaches have recently proven to be successful in problems involving abstract semantic relationships; for example, in architectural design, furniture layout, assembly-based 3D modelling, and colour compatibility applications. Since the goal is to match different clothing items in a sensible manner, and with natural variety conforming to real world observations, a probabilistic machine learning framework trained by real world data is appropriate to encode the matching cost, such that the higher the probability of a particular clothes combination, the lower is its matching cost.

An important issue in establishing the probabilistic relationships between different clothing items relates to their conditional dependencies. For example, the frequent occurrence in the data of a jeans sandals combination and a dress shirt-jeans combination could lead to a dress shirt-jeans-sandals combination style being generated, which should have very low likelihood. Therefore, simply encoding the observed probability of a clothing item and any combination between it with other items is prone to error.

Probabilistic graphical models, in particular, Bayesian networks, are an elegant and efficient choice for learning the implicit relationships among different clothing items consistent with their conditional dependencies. The trained Bayesian networks effectively encode the probability distributions in the space of clothing combinations. An important feature of the Bayesian network is its ability to support conditional query, which is frequently needed in clothes matching. The values of any subset of a clothing combination can be fixed and the probabilities of the remaining clothes can be calculated. For example, given the Business-Casual dress code, one may constrain the upper body to be clothed in a t-shirt and blazer and query the probability of the lower body being clothed in jeans according to the trained distribution. This allows better flexibility to recommend clothing items under different user-specified conditions or scenarios.

### Bayesian Networks for Clothing Relationships

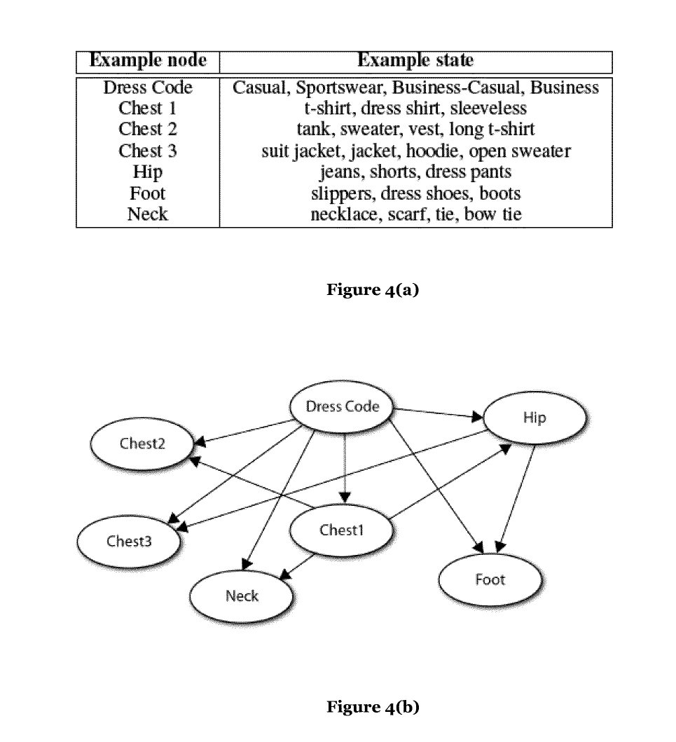

In an embodiment, separate Bayesian networks for men's and women's wear were trained and colour was excluded from the process. In the current system, four dress codes were included: Sportswear, Casual, Business-Casual, and Business. FIGS. 4(a) and 4(b) show part of the Bayesian network for men. The network for women is similar, with differences in some of the node states; e.g., having state dress in node Chest 1.

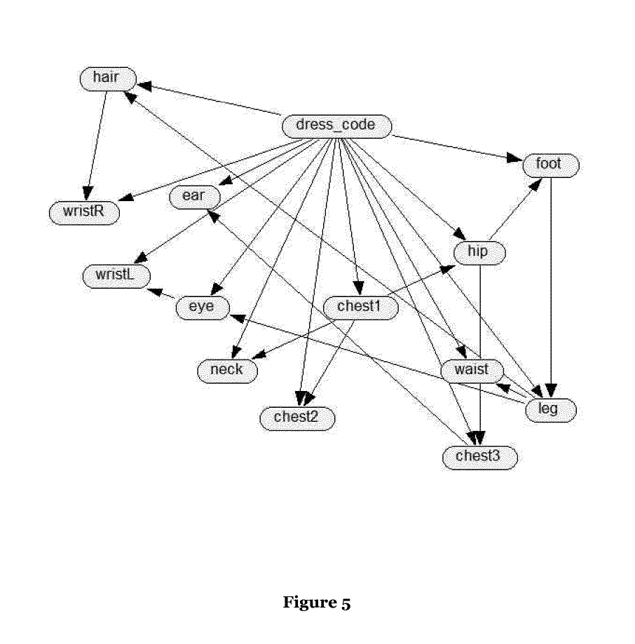

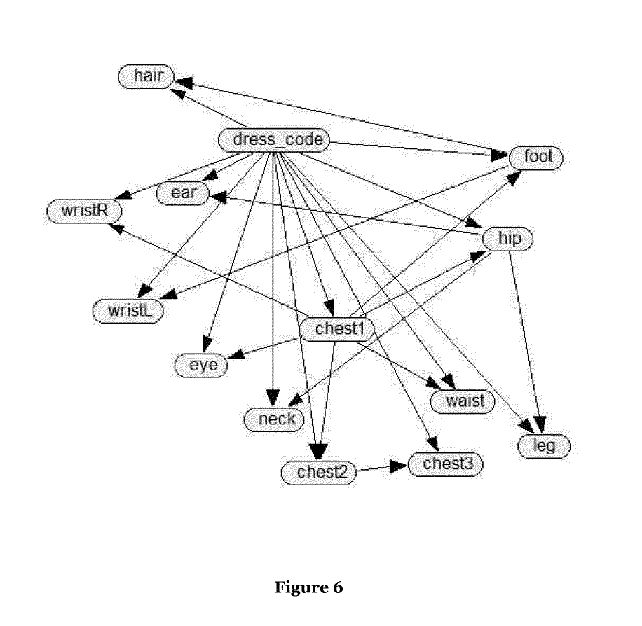

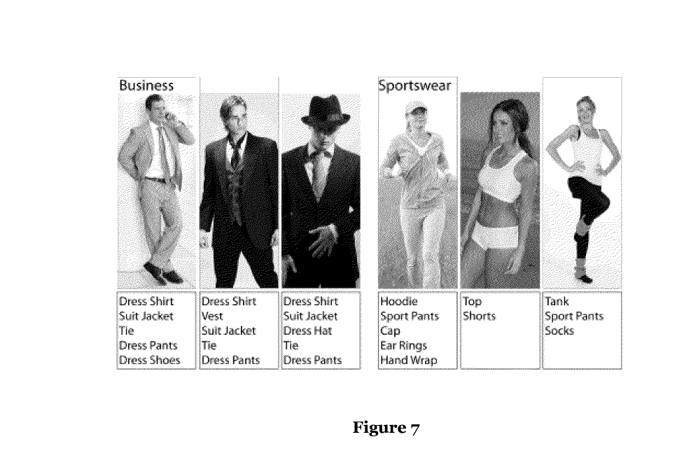

FIG. 5 shows a complete Bayesian network for men and FIG. 6 shows a complete Bayesian network for women. The nodes of the Bayesian networks correspond to different body regions on which a clothing item can be worn, and each node state represents the type of clothing item being worn. For example, the node foot has states dress shoes, slippers, boots, and so on. Except for the node dress code, each node also has a state none, which is used when the node does not carry any clothing item; e.g., foot=none when no shoe is worn. While state choices can be easily modified to suit specific domain needs, as a general case, common classification in boutique websites such as “H&M” and “eBay” are followed.

To handle more complicated situations where there is layering of clothing, a body region can be represented by multiple nodes that correspond to multiple clothing layers. For example, the chest has nodes Chest 1, Chest 2, and Chest 3, with Chest 1 corresponding to the innermost layer (e.g., a t-shirt), Chest 2 to the middle layer (e.g., a vest), and Chest 3 to the outer layer (e.g., a jacket).

The storage means comprises a database of a plurality of images downloaded from Google images for the four dress codes for men and women. Some of the keywords used for obtaining such Google images are ‘casual wear for men’, ‘Business-casual wear for men’, ‘business wear for men’, and similarly for women. Usually, a reasonable quantity of input training data is required. Since some of the downloaded images are not useful, and determining whether the images belong to the dress code is a subjective process, we hired three fashion school students to manually label the attributes of each instance in the network, who used their judgment to disregard inappropriate images. In total, around 2000 labelled data sets for men and women were used to train the Bayesian networks. Labelling each image took about 15-20 sec, and the whole labelling process took 4 hours. FIG. 6 shows some examples of training images for Business and Sportswear. Variety arises when multiple item combinations occur under the same dress code.

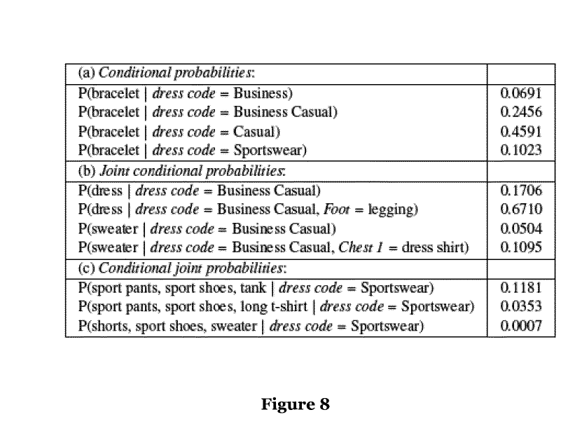

Two clothing attributes should be assigned to two different nodes if the corresponding two clothing items can coexist; e.g., shirt and suit jacket. Otherwise, they should be put under the same node; e.g., sandals and lace-up shoes, since it is not possible to wear both at the same time. The relationships among the plurality of clothing items and their conditional dependencies should be captured. Using the labelled data, the Bayesian network structures for men and women were learnt respectively, by the Tree Augmented Naïve Bayes method which maximizes conditional mutual information between attributes. The conditional probability tables are trained by the Expectation-Maximization algorithm, which can learn the probabilities even if some training data are only partially labelled. Other methods such as maximum likelihood estimation could also be adopted. The results generated using the learnt networks faithfully reproduce our human perceptual requirement for the four dress codes considered. FIG. 8 shows a table with some example queries based on the probabilities captured. Conditional probabilities referred to in the table refer to simple queries by conditional probabilities. Joint conditional probabilities refer to increased joint conditional probabilities which effectively reflect common matching styles such as ‘legging, dress’, ‘dress shirt, sweater’ from the training data. Conditional joint probabilities refer to conditional joint probabilities for more complicated combinations. The advantage of the Bayesian Networks is that they support instant, arbitrary queries.

### Body Colour Tone Classifier

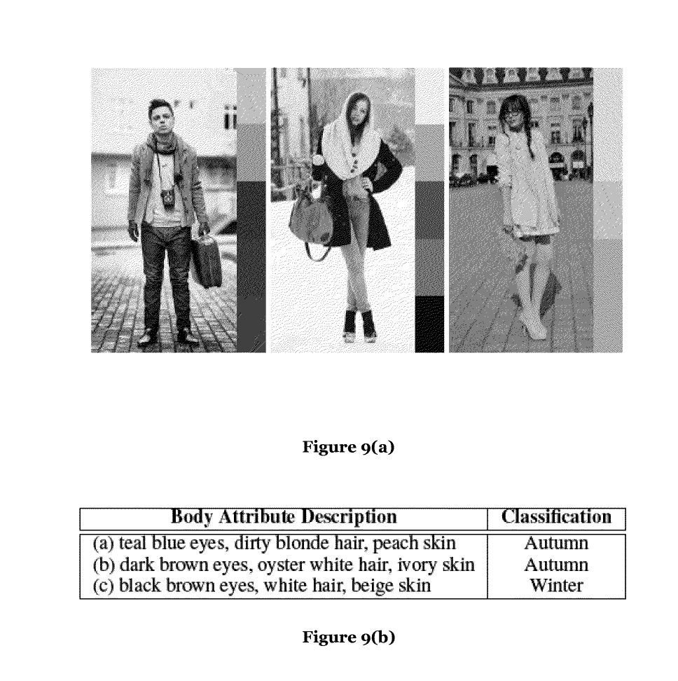

After encoding the probabilistic relationships among the clothing items, the next step is to inform the optimization process of a colour guide. It is a common practice in fashion to first classify a person's body colour tone and then suggest a suitable colour palette for matching clothes for them. There are multiple ways for colour tone classification such as subjective evaluation tests or by “guidelines” or “rules”. However, as shown in FIG. 9(b), the classification “guidelines” can be very obscure and cumbersome, arguably uninterpretable by a general user. The example classification guidelines for a four-season body colour tone are shown in the table in FIG. 9(b). To obtain a classification result, the user must first determine his/or her body attributes according to the description. The description and classification can be obscure to interpret. For example, (a) and (b) in the table have different descriptions but are classified as the same, while (b) and (c) have similar descriptions but are classified as different. There is obviously no unique one-to-one correspondence between body colour attributes and colour tone classification for users to follow.

To this end, a body colour tone predictor means or a classifier to predict the body colour tone of a target person consistent with human preferences is adopted. This has two major advantages. First, subjective evaluation tests commonly adopted in fashion is integrated into a machine learning framework by capturing the subjective evaluation from a number of people. Second, after the classifier is trained, it is intuitive at the user's end—a user simply inputs his/her body colours (e.g., by a few clicks on his/her face photo) and automatically obtains a body colour tone classification result, instead of interpreting obscure descriptions.

To obtain a training dataset, Google Images comprising 1000 facial images were acquired after discarding images with strong illumination effect, including both males and females. For each image, the RGB values of the eye, skin, and two locations in the hair (to encode hair colour variation) were manually extracted. In accordance with common practice in the fashion industry, each image was matched with a set of silver accessories and then with a set of gold accessories, from which a test subject was asked to choose which one they preferred, thus indicating ‘cool’ and ‘warm’ colour tone, respectively. 40 volunteer participants were recruited, including 20 males and 20 females whose ages ranged from 20 to 60, to evaluate the 1000 face images. Evaluation took about 5-10 sec per image. A Support Vector Machine (SVM) classifier was trained and performed cross-validation by randomly choosing 900 data for training and 100 data for testing, achieving a prediction rate of about 77%. Given a previously unseen human body model with specific skin, hair, and eye colours, the trained classifier predicts the body colour tone, thereby recommending either a ‘cool’ or ‘warm’ colour palette to be used in the optimization. Each suggested colour palette may consist of 40 colours, for example. The skin, hair and eye colours may be manually extracted based on visual inspection of the human body model, or may be automatically extracted from one or more images or polygonal meshes using image feature extraction methods known to those skilled in the art.

While the evaluation is by its nature subjective and ambiguous, it was found that in general, people with brownish/reddish hair and brownish/greenish eyes are usually classified as ‘warm’, whereas those with light-coloured hair and dark/bluish eyes are classified as ‘cool’.

### Colour Compatibility Predictor

FIG. 9(a) shows example images extracted from fashion websites such as “Wear Palettes” and “COLOURLovers”, which are usually accompanied by a representative 5-colour palette that supports the colour matching idea Akin to this practice, at each iteration of the optimization, the optimizer extracts a representative 5-colour palette from an outfit and evaluates the colour compatibility of the palette based on the regression model, which is trained by a large number of user-rated colour palettes. The trained regression model can take a 5-colour palette as input, and predict a user preference rating. Fewer or more than 5 colours may be used in the palette, but a 5-colour palette is highly advantageous as it mimics the palette definition convention used in the fashion industry, thereby allowing for easier generation of training data.

### Outfit Optimization

In performing the optimization or generation of outfit generation phase, an embodiment exploits the trained Bayesian networks, body colour tone classifier and colour compatibility predictor described in the above sections. Given a human model, a wardrobe of clothing items and a dress code as inputs, embodiments suggest multiple outfits whose colours are adjusted desirably such that they are compatible to each other guided by the colour palette.

To achieve the objective, a combinatorial optimization problem is solved. Denoting the wardrobe as W, which is a set containing all clothing items, the state of the system is a subset of W, which is referred to as an outfit, φ={θᵢ|i=1, . . . , T}, where each θᵢ=(cᵢ, nᵢ, sᵢ) is preferably a 5-value tuple representing a selected clothing item. The term cᵢ=(rᵢ, gᵢ, bᵢ) contains the RGB values of the clothing item, which are quantized from 0 to 255, nᵢ is the node of the Bayesian network to which this clothing item belongs, and sᵢ is the corresponding node state. For example, nᵢ=foot and sᵢ=dress shoes means that selecting the clothing item θᵢ corresponds to setting the node foot of the Bayesian network to state dress shoes.

In an embodiment, the total number T of selected clothing items is a variable that can be changed. Thus, the dimension of the input space is a variable. The goal is to obtain an outfit φ that minimizes an objective function described in the next section.

### Objective Function

The cost terms constituting the overall objective function are now described.

Style Cost:

In order to obtain the matching cost between different clothing items, at each iteration, every node state of the Bayesian network must be determined. Suppose the network has N nodes (excluding the root node dress code) denoted by x₁, . . . , x_{N}. Given an outfit φ, every node xₖ is instantiated to state S(xₖ) by:

$$S ( {s}_{k} ) = \{ \begin{matrix}{s}_{i} , & {x}_{k} = {n}_{i} \\ none , & {x}_{k} \neq {n}_{i} , ∀ i\end{matrix} \qquad ( 1 )$$

The style cost term has two components C_{style}^{indv} and C_{style}^{joint}. Given dress code=dε{Casual; Sportswear; Business-Casual; Business}, then C_{style}^{indv} encodes the conditional probability of each clothing item. It guides the optimizer by penalizing the selection of clothing items that do not fit dress code d. On the other hand, C_{style}^{joint} defines the conditional joint probability of the clothing item combination:

$$\begin{matrix}{C}_{style}^{indv} ( φ ) = 1 - \frac{1}{N} {\sum }_{k}^{ } P ( S ( {x}_{k} ) \vert dresscode = d ) & ( 2 ) \\ {C}_{style}^{joint} ( φ ) = 1 - P ( S ( {x}_{1} ) , … , S ( {x}_{N} ) \vert dresscode = d ) & ( 3 )\end{matrix}$$

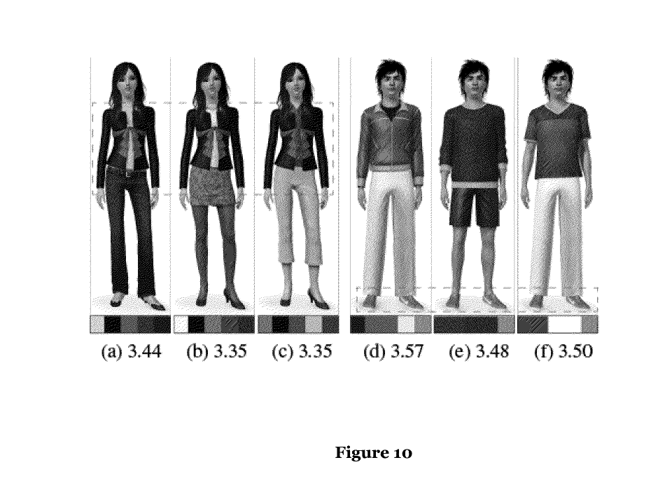

To evaluate these costs, an embodiment makes queries over the Bayesian network to provide the conditional and conditional joint probabilities in (2) and (3). To illustrate the effectiveness of C_{style}^{indv}, suppose the dress code is Business, the initialized outfit is “shirt, jeans, slippers” and another outfit “shirt, dress pants, slippers” is sampled. Although C_{style}^{joint} will evaluate both outfits as unlikely, C_{style}^{indv} will favour the latter, hence effectively guiding the synthesis towards a Business outfit. In case the user fixes one or multiple node states, the fixed node states will become the given conditions. FIG. 10 shows the results with specific items being fixed. In the figure, a fixed black sweater is fixed in (a) to (c), a fixed orange shoe is fixed in (d) to (f) and the colour ratings are shown at the bottom.

### Colour Rating Cost

Similar to the convention in fashion images, a 5-colour palette may be used to represent a clothing combination φ which comprises T selected clothing items, based on a heuristic:
1. Each clothing item is represented by the colour of its largest surface area.
2. Select 5 colours:
   If T=5, select colours from all clothing items.
   If T>5, sort clothing items by their surface areas.
   Select colours from the 5 clothing items with the largest surface areas.
   If T<5, sort clothing items by their surface areas. Duplicate colours of the 5-T clothing items with the largest surface areas. Select the 5-T duplicated colours and the colours of the T clothing items.
3. Sort the 5 selected colours according to their physical position on the body, from top to bottom.

In practice, the outfit comprises at least 2 clothing items, i.e., T>=2. Denoting these ordered 5 colours as λ₁, . . . , λ₅, this is the 5-colour palette representing outfit φ. The colour compatibility cost is

C_{color}^{comp}(φ)=1−[R(λ₁, . . . , λ₅)−1]/4 (4)

In (4), R ε[1, 5] is the regression model, which predicts the user rating of a 5-colour palette, with a higher rating implying higher user preference. The cost in (4) is normalized accordingly.

### Colour Palette Cost

To keep the clothing item colours close to the suggested colour palette, the system calculates the distance of each clothing item's colour cᵢ to each colour cⱼ in the suggested colour palette, and penalizes it if the nearest distance is larger than a threshold h. The colour palette cost term is defined as

$${C}_{color}^{palette} ( φ ) = \frac{1}{T \sqrt{3 {Z}^{2}}} {\sum }_{i}^{ } max ( {min}_{j} ‖ {c}_{i} - {c}_{j} ‖ - h , 0 ) \qquad ( 5 )$$

where Z=255 is the maximum quantized RGB value.

The total cost function is the weighted sum of the above cost terms:

C(φ)=w_{style}^{indv}C_{style}^{indv}(φ)+w_{style}^{joint}C_{style}^{joint}(φ)+w_{color}^{comp}C_{color}^{comp}(φ)+w_{color}^{palette}C_{color}^{palette}(φ) (6)

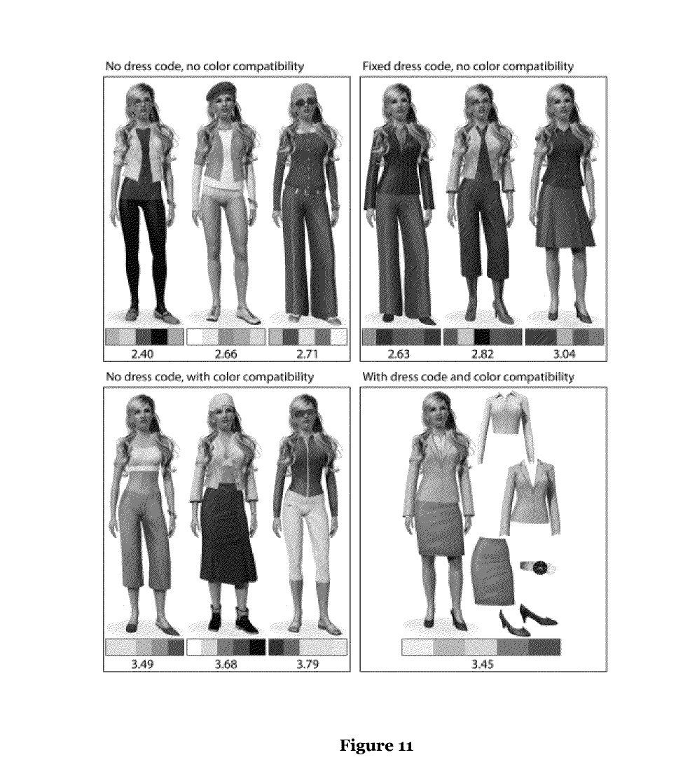

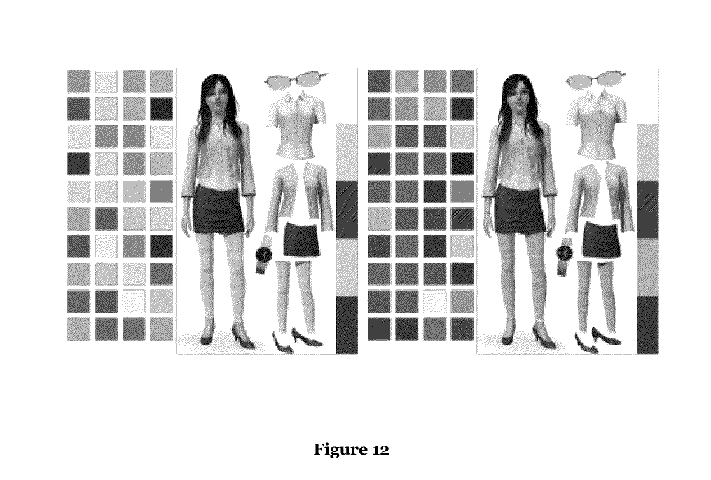

The w coefficients determine the relative weighting between the cost terms; in certain embodiments, w_{style}^{indv}=1.0, w_{style}^{joint}=[5.0,10.0], w_{color}^{comp}=1.0, and w_{color}^{palette}=1.0 is set. The inventors have found that this weighting scheme generates outfit synthesis results which are visually reasonable under respective dress codes. Alternative weighting schemes may be employed if it is desired to enforce stricter compliance with certain requirements; for example, a higher weight could be given to the colour palette if one wanted to make sure that the colour palette was strictly followed. FIG. 11 shows the effect of omitting the style and colour cost terms. The top left image shows the effect of no dress code and no colour optimization. The top right image shows the effect of fixed dress code and no colour optimization. The bottom left image shows the effect of no dress code but with colour optimization. The bottom right image shows the effect of fixed dress code with colour optimization. FIG. 12 illustrates the effect of using different colour palettes.

### Reversible Jump Markov Chain Monte Carlo

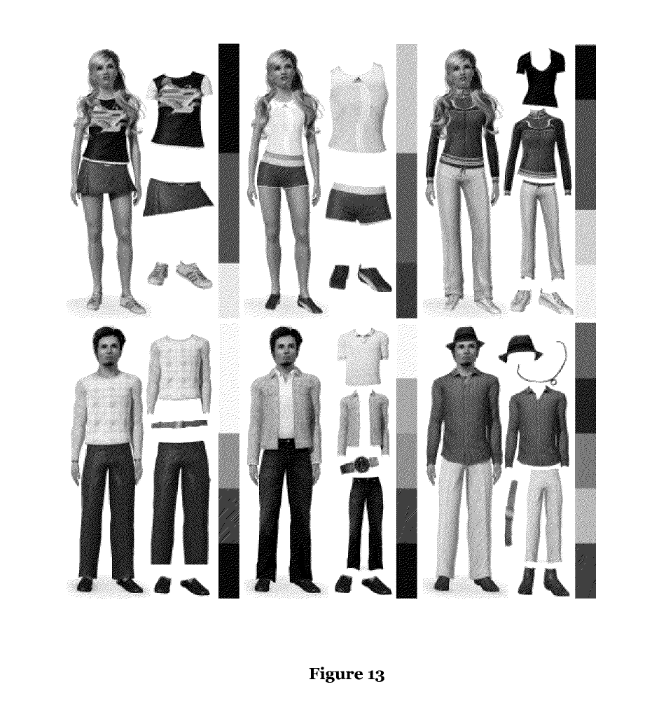

Since the optimization problem is combinatorial and the number of combination items can vary (e.g., a jacket can be added or removed), it is difficult to define a closed-form solution. In fact, as in the real world, it is desirable to obtain multiple optimal solutions (outfits) from the same wardrobe instead of a single global optimum. This motivates the generation of candidate solutions by sampling a density function defined over the space of possible outfits. The density function is defined using idealized analytical formulations. Sampling is preferably performed using a Markov Chain Monte Carlo sampler. FIG. 13 shows multiple optimal outfit suggestions generated with the dressed models and the corresponding clothing items. The top images are for the dress code Sportswear and the bottom images are for the dress code Business-Casual. The recommendations from the left to right images are arranged in descending matching cost value.

One of the difficulties for the optimization problem is that its dimensionality may change; i.e., the number of clothing items may be altered during the optimization process. To deal with this complication, the Reversible Jump MCMC (RJMCMC) framework is adopted which can be considered a generalization of the original Metropolis-Hastings (MH) algorithm. RJMCMC works by supplementing the parameter-changing diffusion moves of MH with an additional set of dimension-altering jump moves, which allow the chain to move between subspaces of different dimension. RJMCMC has been successfully applied to other graphics and vision problems such as procedural modelling and image segmentation.

### Annealing

To efficiently explore the solution space, the simulated annealing technique is applied in the optimization process. A Boltzmann-like objective function is defined as follows:

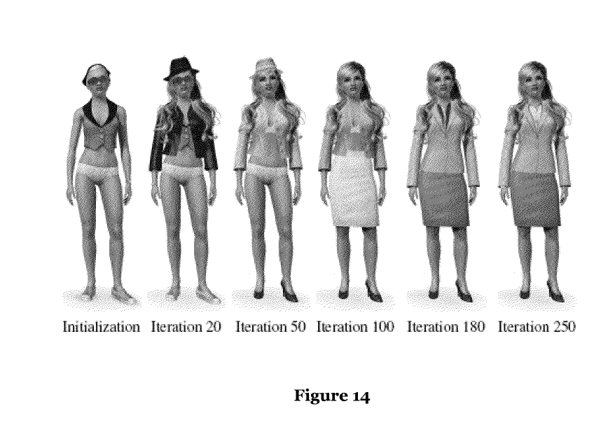

ƒ(φ)=exp(−βC(φ)) (7)

where β is a constant inversely proportional to the temperature of the annealing process. At the beginning of optimization, β is set to a low value, equivalent to setting a high temperature, which allows the sampler to more aggressively explore the solution space. Then β is gradually increased throughout the optimization. Near the end, β attains a large value, equivalent to setting the temperature near zero, thereby allowing the sampler to refine the solution. FIG. 14 shows the iterative optimization process.

### Proposed Move

A dimension matching strategy is adopted to allow reversible jumps across subspaces of different dimension or within the same subspace. At each iteration of the optimization, a move m′ε{mₐ, mᵣ, mₛ, mₘ} is chosen with probability p_{m′}. Associated with the move is a move-specific proposal distribution q_{m′}( ), which is a function of an auxiliary variable U′. As move m′ is chosen, a sample of the auxiliary variable U′ is drawn from q_{m′}(U′), which modifies the current outfit φ to a proposed new outfit φ′ by a deterministic function φ′=h(φ, U′). The reverse move m is computed, which reverts φ′ back to φ, by sampling U from qₘ(U) such that φ=h*(φ′, U). The proposed outfit φ′ is then accepted with probability

$$α ( {φ}^{′} \vert φ ) = min ( 1 , \frac{{p}_{m}}{{p}_{{m}^{′}}} \frac{{q}_{m} ( U )}{{q}_{{m}^{′}} ( {U}^{′} )} \vert \frac{\partial ( {φ}^{′} , U )}{\partial ( φ , {U}^{′} )} \vert \frac{p ( {φ}^{′} )}{p ( φ )} ) , \qquad ( 8 )$$

where |∂(φ′,U)|∂(φ,U′)| is the Jacobian of the diffeomorphism from (φ,U′) to (φ′,U). Defining φ′=h(φ,U′)=U′ and φ=h*(φ′,U)=U, the Jacobian is unity.

Based on the RJMCMC formulation, the natural strategy is followed to define the jump moves as adding/removing a clothing item to/from the outfit, which induce a dimension change, and diffusion moves as swapping items or modifying an item's colour, which involve no dimension change, as follows:

Adding an Item (mₐ):

Randomly pick an available clothing item θⱼ from wardrobe W and add it to outfit φ, so that φ′=φ∪{θⱼ}.

Removing an Item (mᵣ):

Randomly remove a selected clothing item θᵢ from outfit φ, so that φ′=φ\{θᵢ}.

Swapping Items (mₛ):

Randomly pick a selected clothing item θᵢ from outfit φ, and swap it with an available clothing item θⱼ from wardrobe W, so that φ′=φ\{θᵢ}═{θⱼ}.

Modifying an Item Colour (mₘ):

Randomly pick a selected clothing item θᵢ from outfit φ and change its colour cᵢ. Hence, θᵢ is updated as: θᵢ′=(cᵢ+δcᵢ, nᵢ, sᵢ), where δcᵢ˜[N(0,σ_{c}²)N(0,σ_{c}²)N(0,σ_{c}²)]^{T} and with

$$N ( μ , {σ}^{2} ) = {( 2 π {σ}^{2} )}^{- 1 / 2} {e}^{- \frac{{( x - μ )}^{2}}{2 {σ}^{2}}} ,$$

a Gaussian distribution having mean μ and variance σ². The variance σ_{c}² which determines the average magnitude of the change, is proportional to the temperature.

The acceptance probabilities of the proposed RJMCMC moves are:

Adding an Item (mₐ):

$$\begin{matrix}α ( {φ}^{′} \vert φ ) = min ( 1 , \frac{{p}_{r}}{{p}_{a}} \frac{\frac{1}{\vert {φ}^{′} \vert}}{\frac{1}{\vert W \text{\textbackslash} φ \vert}} \frac{f ( {φ}^{′} )}{f ( φ )} ) & ( 9 ) \\ = min ( 1 , \frac{{p}_{r}}{{p}_{a}} \frac{\vert W \text{\textbackslash} φ \vert}{\vert {φ}^{′} \vert} \frac{f ( {φ}^{′} )}{f ( φ )} ) . & ( 10 )\end{matrix} \qquad$$

Removing an Item (mᵣ):

$$\begin{matrix}α ( {φ}^{′} \vert φ ) = min ( 1 , \frac{{p}_{a}}{{p}_{r}} \frac{\frac{1}{\vert W \text{\textbackslash} {φ}^{′} \vert}}{\frac{1}{\vert φ \vert}} \frac{f ( {φ}^{′} )}{f ( φ )} ) & ( 11 ) \\ = min ( 1 , \frac{{p}_{a}}{{p}_{r}} \frac{\vert φ \vert}{\vert W \text{\textbackslash} {φ}^{′} \vert} \frac{f ( {φ}^{′} )}{f ( φ )} ) . & ( 12 )\end{matrix}$$

Swapping Items (mₛ):

$$\begin{matrix}α ( {φ}^{′} \vert φ ) = min ( 1 , \frac{{p}_{s}}{{p}_{s}} \frac{\frac{1}{\vert {φ}^{′} \vert} \frac{1}{\vert W \vert}}{\frac{1}{\vert φ \vert} \frac{1}{\vert W \vert}} \frac{f ( {φ}^{′} )}{f ( φ )} ) & ( 13 ) \\ = min ( 1 , \frac{f ( {φ}^{′} )}{f ( φ )} ) . & ( 14 )\end{matrix}$$

Modifying an Item Colour (mₘ):

$$\begin{matrix}α ( {φ}^{′} \vert φ ) = min ( 1 , \frac{{p}_{m}}{{p}_{m}} \frac{p ( {θ}_{i} \vert {θ}_{i}^{′} )}{p ( {θ}_{i}^{′} \vert {θ}_{i} )} \frac{f ( {φ}^{′} )}{f ( φ )} ) & ( 15 ) \\ = min ( 1 , \frac{f ( {φ}^{′} )}{f ( φ )} ) . & ( 16 )\end{matrix}$$

In one implementation, the prior distribution is set uniformly over the moves as pₐ=pᵣ=pₛ=Pₘ=0.25. In other embodiments it may be desirable to have unequal probabilities, for example to assign a higher probability to colour-change moves, in order to improve optimization speed or to generate more variation around an optimum, for example.

### Results and Discussion of Applications

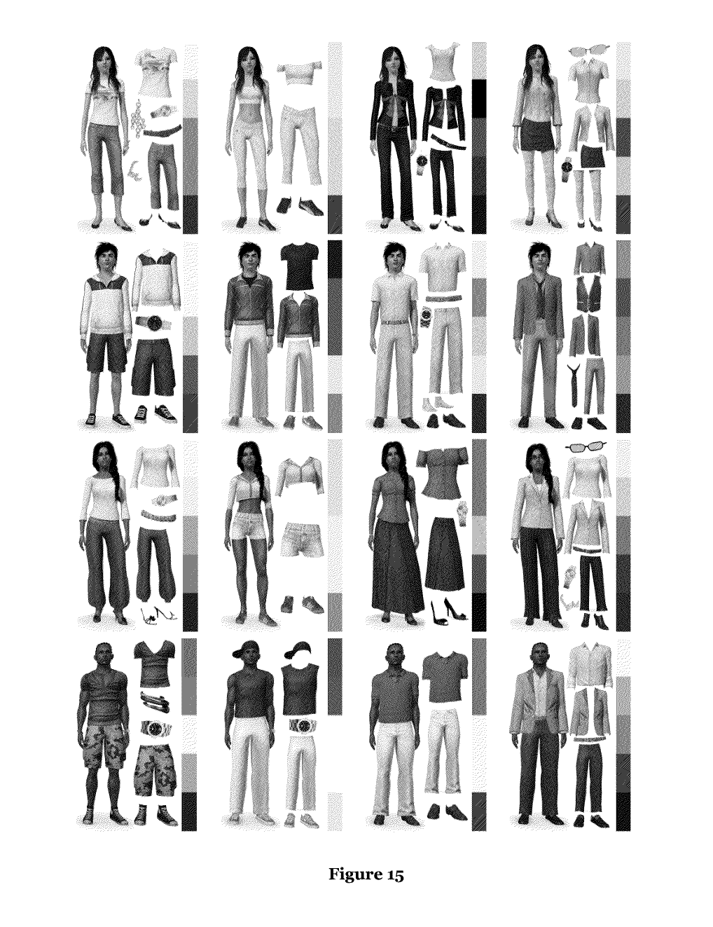

The efficacy of the optimization approach was tested on six different virtual human models, three males and three females. FIG. 15 depicts two males and two females. For the males, “Thor” has white skin and dark brown hair, “Eddie” has yellow skin and black hair, and “Jacen” has black skin and black hair. For the females, “Fiona” has white skin and blonde hair, “Mag” has yellow skin and black hair, and “Ce” has dark brown skin and black hair.

All four dress codes Sportswear, Casual, Business-Casual and Business for all the models were synthesized. The male and female model outfits were optimized using the Bayesian networks learned for males and females, respectively. The clothing items are also segregated into male and female wardrobes. Each wardrobe contains about 10 clothing items for each of the 40 states in the Bayesian network, so there are about 400 clothing items in total. A budget of 250 optimization iterations for each outfit synthesis was used, which takes about 1-2 second per synthesis on a 3.33 GHz Intel Xeon PC.

The final optimized outfits with the corresponding selected items are shown in FIG. 15. The corresponding 5-colour palette alongside with the items is also shown. Mag and Eddie are classified as ‘cool’ and a ‘cool’ colour palette was assigned to them prior to the optimization. Meanwhile Ce and Jacen are classified as ‘warm’. The ‘cool’ and ‘warm’ colour palettes are shown in FIG. 3. For all the generated results, the colour ratings are greater than 3.3. The dress code as the root node determines the style of synthesis; i.e. what clothing items should be chosen and how they should combine. For example, in the 3rd row showing the synthesis for Ce, the same sweater is chosen for Casual and Business. However, the sweater is worn alone in Casual, but with a suit jacket in Business. When the Bayesian networks were designed, more than one node was defined for the chest to permit the coexistence of different items. Several generated results reflect this property, which is important for creating variation. It happens more often for the dress code Business; for example, Eddie in the 2nd row wears a dress shirt, a vest, and a suit jacket for his upper body outfit, a combination which is occasionally observed in the Business training data.

The outfit suggestion optimization has a number of potential applications, for example as follows.

Outfit Suggestion Engine:

The outfit suggestions can readily assist shoppers in boutique websites or fitting rooms, in which case the clothing items are those available in the store; or it can be used as a personal outfit advisor, in which case the clothing items are those available in the user's wardrobe. The support of efficient, arbitrary probabilistic queries can handle scenarios commonly encountered in the clothes matching process. For example, conditional queries allow one to fix one or multiple clothing items and ask for multiple matching suggestions. FIG. 10 shows two examples of results with the specific clothing items being fixed. One can also change the preferred colour palette, after which the optimizer will update the suggestion accordingly, as shown in FIG. 12. As a personal outfit advisor, given a dress code, it can automatically suggest many decent outfits out of the user's wardrobe, thereby making full use of it. Refer to FIG. 13 for two examples.

In one implementation, a server component of an online shopping system such as eBay communicates with a database in which is stored wardrobe data relating to all clothing items and accessories which are available in one or more virtual stores within the online shopping system. The database also stores user account information. An outfit suggestion component, configured to perform the methods described above, is in communication with the server component and the database. The server component receives, from a client component, user input data relating to one or more input parameters, such as body colours of the user, dress code, or specific clothing items owned by the user (which may or may not already be included in the wardrobe data).

The server component transmits the user input data to the outfit suggestion component, which generates one or more outfit suggestions based on the optimization methods described above. The server component then receives the outfit suggestion(s) and communicates them to the client component.

The client component may include a user interface component to accept the user input data, for example by entry of text relating to the input parameters, or by upload of an image of the user. The image can be displayed as part of a click interface to allow the user to define parameters by clicking on various body parts, or can be passed to an image analysis component to automatically segment the image and extract the relevant body part information by methods known in the art.

In some embodiments, the user's purchase history, retained as part of their account information, may be used as training data for a Bayesian network component associated with the outfit suggestion component. For example, if the user has previously purchased sports shoes and a vest in the same purchase, the Bayesian network component may recognise that sports shoes and vests should both belong to a Sportswear outfit.

Virtual Character Modelling:

Our approach is also useful for dressing human-like characters in large-scale virtual worlds, in which case the artist can specify dress codes and allow the computer to synthesize coordinated clothing combinations for each character in a fully automated manner. In another implementation, therefore, an outfit suggestion component may form part of, or be associated with, a character modelling engine in a gaming application. Gaming applications commonly support automatic clothes meshing on virtual characters (examples include Playstation home, XBOX 360 Avatars, the Sims, Second Life, etc.), but lack support for reasoning about the many possible outfits out of the massive amount of clothing items available. The player experience can be significantly enhanced by having the character modelling engine interact with an outfit suggestion component according to embodiments. The character modelling engine may generate input data such as dress code and body coloration of a virtual character, and the input data may be passed to the outfit suggestion component to generate at least one, and preferably multiple, optimal or near-optimal outfit suggestions along the lines described above, for presentation to the player.

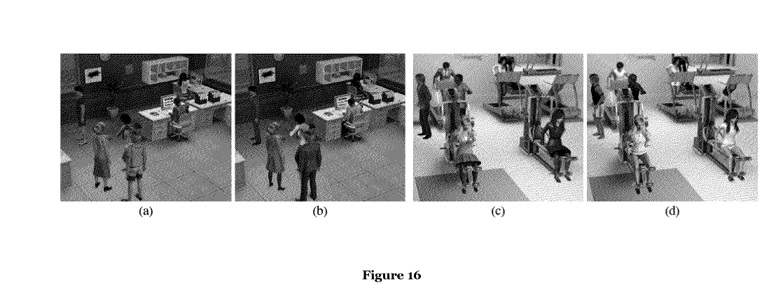

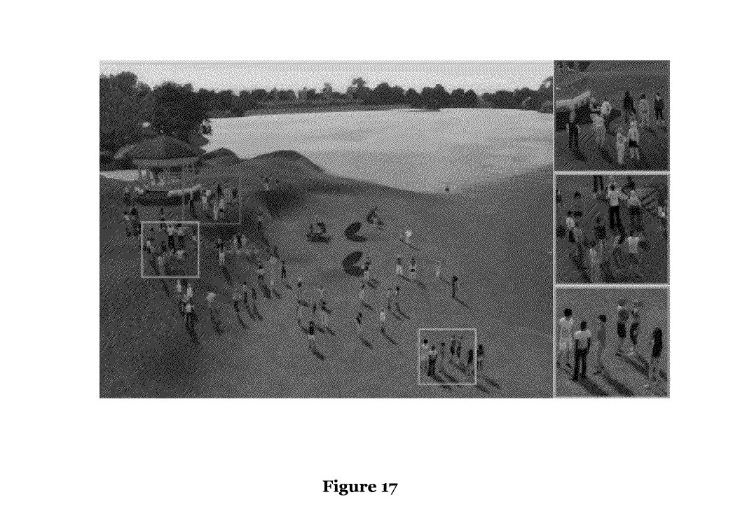

FIG. 16 shows virtual scenes with and without outfit consideration. FIG. 16(a) is a view of outfits being generated randomly. FIGS. 16(b) and (c) is a view of outfits being generated according to embodiments under dress code Business. FIG. 16(d) shows a view of outfits regenerated after changing the dress code to Sportswear. An unnatural appearance clearly results in the absence of a proper dress code. Therefore, one can easily see that the scene appears unnatural if the characters are not properly dressed; e.g., donning a suit jacket, or wearing a dress in a gym, or dressing in sportswear in the office. FIG. 17 shows a beach scene populated by approximately 100 virtual characters automatically dressed up according to embodiments in Sportswear and Casual dress codes. With the optimization, the characters can be appropriately dressed in multiple ways to create variety suitable to the scene.

In another application, an outfit suggestion method according to embodiments may be used as part of, or in association with, fashion design software such as Marvelous Designer. During the design process for a particular clothing item, the fashion design software may pass the current design to an outfit suggestion component implementing the method, which in turn generates (for display in a user interface of the fashion design software) suggested relevant clothing items to make a good outfit, with the colours of all the clothing items automatically being optimized by the outfit suggestion component to give a good colour match.

While the approach is demonstrated based on the four dress codes that are common nowadays, there is flexibility to cope with specific clothing styles matching a theme. An interesting example is for a massively-multiplayer online game featuring the Medieval Fantasy, in which case the node states can be replaced by medieval clothes and specific nodes such as “weapon” may be added. In this case, training examples may be collected directly from the player-created game characters, and outfit suggestions in the character modelling engine can be used by new players, or for the automatic, realistic synthesis and dressing of non-player characters.

### Perceptual Study

A perceptual study was performed to evaluate the functional and visual appearance. Since comparisons of outfits are inherently subjective, one possible way is to evaluate the synthesized results against comparable results produced by human fashion designers. However, assessing metrics and performing pairwise comparisons is very difficult when there are significant differences, and they may not lead to meaningful conclusions. For example, a particular subject may be fond of some particular skirt and be biased in favour of women wearing this skirt. Thus visually reasonable or pleasing outfits may be synthesised under certain dress codes. The clothing items may enforce the selected dress code and their colours may be nicely coordinated. The following two conditions were verified, by two experiments: First, a classification experiment to testify that the outfit recommendations produced successfully reflect the dress code and, hence, validate the Bayesian network training. Second, a discrimination experiment to verify that the incorporated dress code yields a benefit over outfit synthesis results obtained in its absence.

Experiments were conducted using a subjective, five-alternative/two-alternative, forced choice preference approach. In Experiment 1, the null hypothesis H₀ was that users cannot recognize the dress code of the syntheses for each category; i.e., recognition rate is at chance level. In Experiment 2, the null hypothesis H₀ was that users show no preference among the syntheses with and without dress code consideration.

Participants:

32 volunteer participants were recruited who were unaware of the purpose of the perceptual study. The participants included 16 males and 16 females whose ages ranged from 20 to 60. All the subjects reported normal or corrected-to-normal vision with no colour-blindness and reported that they are familiar with the dress codes to be tested in the study. 29 subjects reported that they did not have any expertise in fashion design.

Data:

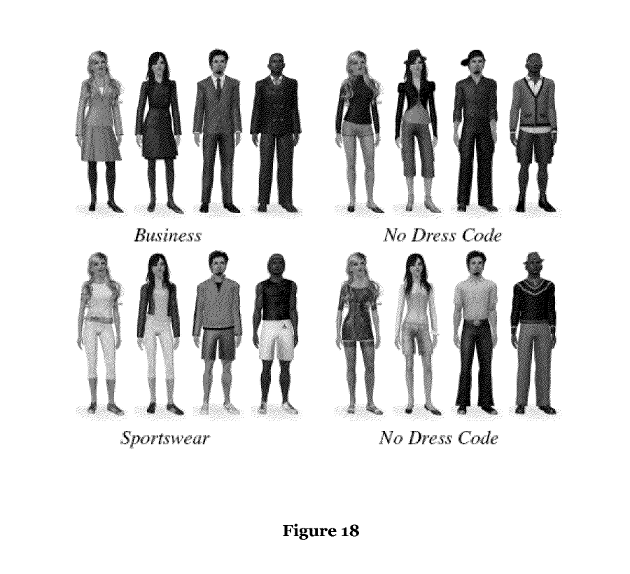

4 virtual models were picked to cover both genders: Thor and Jacen are male, Fiona and Mag are female. For each virtual model, 20 outfits were synthesized (5 per dress code) with the complete objective function, and 20 outfits with an objective function lacking the style cost term. FIG. 15 depicts example matching results with their associated items used in the user study. For the pairwise comparison, examples are shown in FIG. 18 which are example images of Experiment 2. On the left, the outfits were synthesized with the corresponding dress codes. On the right, the outfits were synthesized without dress code consideration. With multiple outfits per dress code, a variety in the comparisons can be created.

Procedure:

The study was conducted in two experiments. Participants were encouraged to ask any question prior to the study. After completing a consent form and questionnaire, they were given a sheet detailing the task descriptions.

Experiment 1 (Classification):

The main goal was to test whether the generated results reflect the corresponding dress code faithfully and, hence, verify the Bayesian network encoding. To achieve this, the subject was asked whether the synthesized clothing combinations fall into any of the encoded dress codes:
“This experiment involves selecting a dress code from an image of a dressed model. There are 80 images. Your task in each evaluation is to select one of the following dress codes which you feel best describes the outfit shown in the image: Sportswear, Casual, Business-Casual, Business, and Other if the image does not match any of the previous four. You can view the test image for an unlimited amount of time, but we suggest that you spend around 15 seconds on each image before making your selection.”

Experiment 2 (Discrimination):

The main goal was to evaluate if incorporating the style cost term really shows a significant preference on the functionality of the outfit compared to outfits synthesized without consideration of a dress code:
“This experiment involves selecting a dressed model from a pair of images, and there are 160 pairs in total. You will be shown the images side-by-side with a grey image displayed between each evaluation. Your task in each evaluation is to select the model based on their outfit in which you would prefer to dress for a particular occasion which is depicted in the top of the image pairs: Casual, Sportswear, Business-Casual, or Business. You can view the test pair for an unlimited amount of time, but we suggest that you spend around 15 seconds on each pair before making your selection.”

Each participant viewed a total of 160 trials (4 models×4 dress codes×5 pairs×2 trials). Each pair comprises a full objective result and a result randomly chosen among those synthesized without considering the style cost term. The pairs were presented to each participant in a different random order. Counterbalancing was used to avoid any order bias—each paired comparison was assessed twice by each participant: In half of the trials the full objective result was displayed on the left side and in the other half on the right.

Results and Analysis:

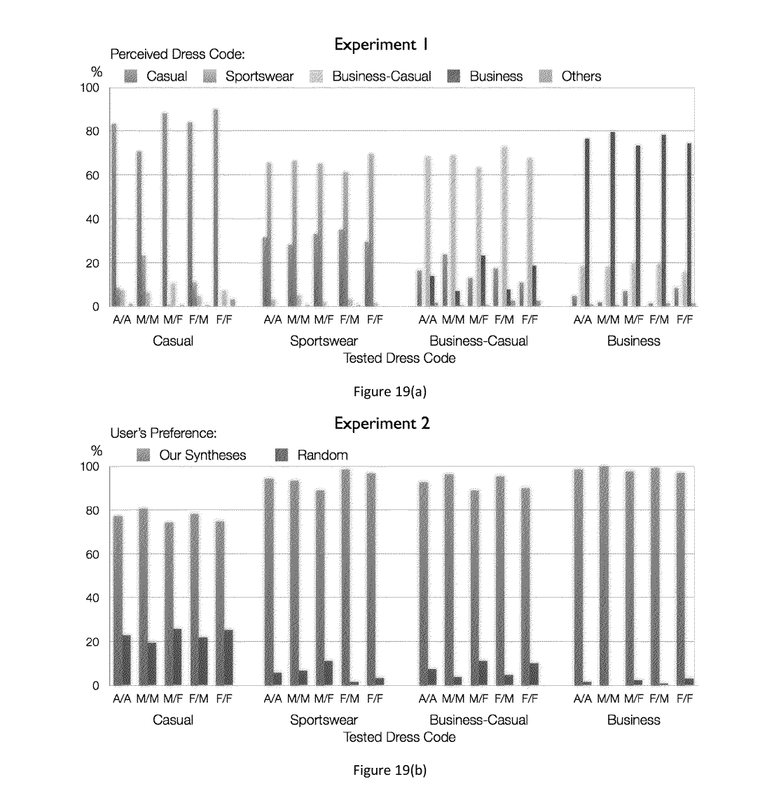

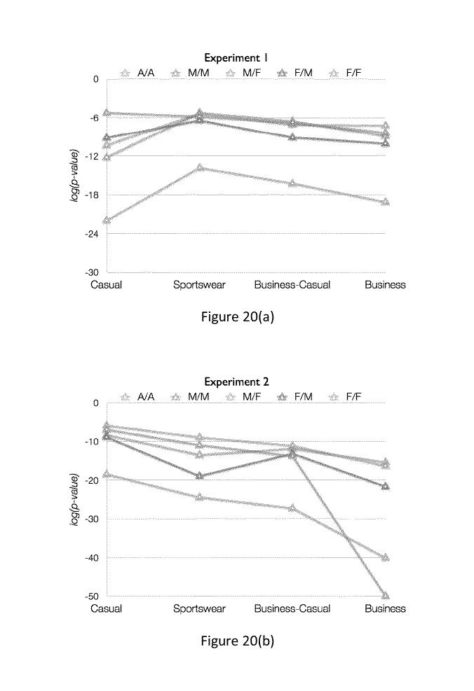

FIG. 19(a) shows the correct recognition rates of Experiment 1, perceived dress code versus tested dress code. “A/A” represents all participants perceiving all synthesis. “M/F” represents male participants perceiving female syntheses. Similarly, for “M/F”, “F/M” and “F/F”. All recognition rates are significantly above chance level. The results by gender of the participants versus the gender of the syntheses are displayed. Overall, the correct recognition rates are: Casual (83.125%), Sportswear (66.875%), Business-Casual (67.969%), Business (76.25%).

FIG. 19(a) also shows some interesting observations. While all correct recognition rates were significantly above chance, Sportswear and Business-Casual have lower recognition rates. A certain portion of Sportswear was perceived as Casual, while a certain portion of Business-Casual was perceived as Business and Casual, respectively. This is probably because in reality, the perception of different dress codes can be ambiguous and may overlap; e.g., some people may regard a subset of Sportswear and a subset of Business-Casual also as belonging to Casual, which tends to be more frequently chosen as a result and received higher recognition rates. This also accounts for the recognition rates of Business that have minor portions perceived as Business Casual, which if added up together should give rates over 90% for both genders.

With respect to gender difference, we note that men's Business tend to be more definitive than women's Business, with slightly higher correct recognition rates on men's Business syntheses and less men's Business-Casual syntheses being perceived as Business. On the contrary, men's Casual tend to have more overlap with Sportswear perceptually. The Casual plot shows a certain portion of men's Casual being perceived as Sportswear, while this is rarely the case for women's Casual. Finally, it is noted that male and female participants tend to give similar response trends in classification.

FIG. 19(b) depicts the results of Experiment 2 by comparing the rates of choosing the synthesized outfit and random syntheses. In all the cases the syntheses are much more preferable than random syntheses. Notice that the relatively lower recognition rates on dress code Casual, which is not surprising due to its less restrictive nature. To ascertain that the results are significant, t-tests were performed against chance in both experiments. FIG. 19 shows the results of the t-tests against chance for Experiment 1 (on the left) and 2 (on the right shown as log (p-value)). The notations used are the same as in FIG. 19(a). The test for A/A has d.f.=31. Other tests have d.f.=15. All tests have log(p-value)<−5 which is equivalent to p-value<0.00001. In all cases, we have p-values less than 0.00001, which are very small. Therefore, we reject the null hypothesis H₀ in both experiments. For Experiment 1, this concludes that subjects can correctly recognize the dress code of the syntheses as one of the 4 encoded dress codes. For Experiment 2, this concludes that subjects also prefer the syntheses that include dress code consideration.

A method and system for outfit synthesis is presented, which is a highly practical topic both in daily life and computer graphics. The approach optimizes outfits in a way similar to real world situations. The body colour tone classifier automates the classification pre-process in fashion practices, avoiding cumbersome, obscure, manual classification. From the user's perspective, the method is highly intuitive in practical use. On the one hand, if one fixes item colours and permits only addition, removal, or swapping moves during optimization, one is mimicking the scenario of a fixed wardrobe, and the optimizer jointly considers style and colour when synthesizing outfits out of the available clothing items. On the other hand, if one permits the changing of certain clothing item colours, this is similar to buying new clothes, and it is particularly useful for populating virtual worlds with characters that exhibit realistic sartorial variety.

Currently, four different dress codes have been incorporated, but it is flexible enough to accommodate additional criteria such as season, texture pattern, clothing shape, age, body proportion, or even associating outfits with multiple dress codes during training. For example, a series of training examples in which the outfit belongs to multiple dress codes may be used to train separate Bayesian networks for the respective dress codes. In order to incorporate additional criteria, additional descriptors for each clothing item could be used. For example, a t-shirt could more specifically be defined as a “hip-hop t-shirt”, a “rock t-shirt” or a “punk t-shirt”, and when annotating the training data, the “hip-hopness”, “rockiness” or “punkness” of the t-shirt could be specified. For simplicity, each clothing item is assumed to be represented by its dominant colour. More sophisticated representations, such as representing each clothing item with an arbitrary number of colours (e.g., one colour for a plain shirt and two colours for a checkered shirt), can be readily handled by our RJMCMC formulation, which flexibly allows varying the number of dimensions. On the other hand, the colour palette suggestion is motivated from the fashion literature, and it is easy for users to change according to their own preference; e.g., using a more colourful palette for a festive occasion; or replacing the colour palette with one tailor-made by a fashion professional for a specific client; or trained by large-scale commercial datasets. The seemingly abstract fashion matching problem may be formulated as a combinatorial optimization problem in which style and colour are jointly considered.

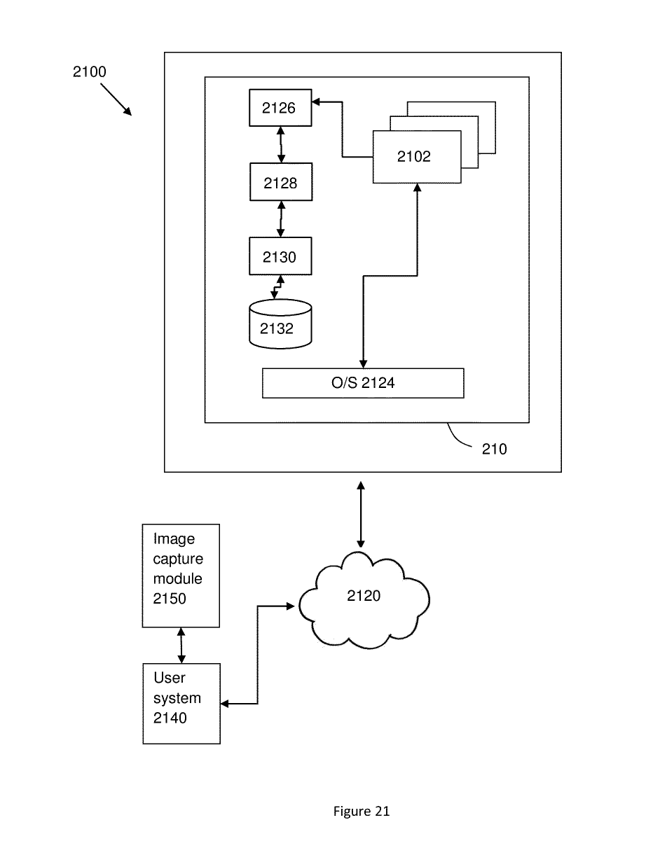

In general, the methods described herein may be embodied in a data processing system which may or may not include components for automatically capturing and processing images of a plurality of clothing items, e.g. from a user's wardrobe, and/or capturing and processing images of a user. By way of example, in one embodiment, the data processing system is a standard computer system such as a 32-bit or 64-bit Intel Architecture computer system 2100, as shown in FIG. 21, and the methods executed by the system 2100 are implemented in the form of programming instructions of one or more software modules or components 2102 stored on a non-volatile (e.g., solid-state or hard disk) storage medium 2104 associated with the system 2100, as shown in FIG. 21. However, it will be apparent to those skilled in the art that the methods could alternatively be implemented, either in part or in their entirety, in the form of one or more dedicated hardware components, such as application-specific integrated circuits (ASICs), and/or in the form of configuration data for configurable hardware components such as field programmable gate arrays (FPGAs), for example.

The system 2100 shown in FIG. 21 includes standard computer components, including random access memory (RAM), at least one processor, and external interfaces, all interconnected by a bus. The external interfaces include universal serial bus (USB) interfaces, at least one of which is connected to a keyboard and pointing device such as a mouse, a network interface connector (NIC) which connects the system 2100 to a communications network 2120 such as the Internet, via which user input and other data can be accessed by the system 2100. The system 2100 also includes a display adapter, which is connected to a display device such as an LCD panel display, and a number of standard software modules, including an operating system 2124 such as Linux or Microsoft Windows, web server software 2126 such as Apache, available at http://www.apache.org, scripting language support 2128 such as PHP, available at http://www.php.net, or Microsoft ASP, and structured query language (SQL) support 2130 such as MySQL, available from http://www.mysql.com, which allows data to be stored in and retrieved from an SQL database 2132.

Together, the web server 2126, scripting language 2128, and SQL modules 2130 provide the system 2100 with the general ability to allow client computing devices 2140 equipped with standard web browser software to access the system 2100 and in particular to provide data to and receive data from the database 2132.

Thus in some embodiments, the components 2102 are configured to:

retrieve or otherwise access stored wardrobe data representing a plurality of clothing items;

retrieve or otherwise access probabilistic model data representing a probabilistic model, the probabilistic model comprising probabilities of the clothing items being matched with each other conditional on one or more parameters;

receive user input, for example via user system 2140 which communicates with system 2100 via WAN 2120, relating to at least one of the one or more parameters; and process the user input, the probabilistic model data and the wardrobe data to generate one or more optimal or near-optimal outfit suggestions from the wardrobe data based on the probabilistic model data and the user input.

In some embodiments, an image capture module 2150 may capture one or more images of a user, and transmit the image data to system 2100 (either via user system 2140, or directly) for use in generating a body colour tone classification for the user. The image capture module 2150 may comprise a digital camera, a 3D scanning apparatus, or a motion sensing device such as Kinect of Microsoft Corporation, or Xtion of ASUSTeK Computer Inc., in conjunction with suitable reconstruction software such as Skanect of ManCTL (skanect.manctl.com), for example.

Components 2102 may comprise:

a graphical model component, such as a Bayesian network component, for learning relationships between clothing items in the wardrobe data which are stored in database 2132; and

an optimization component in communication with the graphical model component for generating outfit suggestions based on user input data, the wardrobe data and the learned relationships output by the graphical model component.

The optimization component may implement the RJMCMC method described above in conjunction with simulated annealing, for example.

Unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the above will be apparent to the person skilled in the art without departing from the spirit and scope of the invention and it is intended that all such modifications and adaptations come within the scope of the appended claims. For example, although in the described embodiments Bayesian networks have been employed as the probabilistic model which is used to learn and describe the relationship between the different types of clothes, other graphical models (which may employ graph kernel based methods for learning, for example) may be used. Further, any number of constraints may be added to the optimization process provided each constraint can be expressed mathematically as a cost term.

1. A computer-implemented method for generating an outfit suggestion, comprising:
providing wardrobe data representing a plurality of clothing items;
providing probabilistic model data representing a probabilistic model, the probabilistic model comprising probabilities of the clothing items being matched with each other conditional on one or more parameters;
receiving user input relating to at least one of the one or more parameters; and
performing an optimization to generate one or more optimal or near-optimal outfit suggestions from the wardrobe data based on the probabilistic model data and the user input.

2. A computer-implemented method according to claim 1, wherein the probabilistic model is a graphical model.

3. A computer-implemented method according to claim 2, wherein the graphical model is a Bayesian network.

4. A computer-implemented method according to any one of the preceding claims, wherein optimization comprises iteratively: (i) randomly generating a proposed outfit based on a current outfit; (ii) accepting or rejecting the proposed outfit based on the probabilistic model data; and (iii) if the proposed outfit is accepted, updating the current outfit to be the proposed outfit.

5. A computer-implemented method according to claim 4, wherein the optimization comprises a Markov Chain Monte Carlo (MCMC) method.

6. A computer-implemented method according to claim 5, wherein the optimization comprises a Reversible Jump MCMC method.

7. A computer-implemented method according to any one claims 4 to 6, wherein the optimization comprises simulated annealing.

8. A computer-implemented method according to any one of claims 4 to 7, wherein randomly generating a proposed outfit comprises modifying the current outfit by one of: adding a clothing item randomly selected from the plurality of clothing items; randomly removing a clothing item from the current outfit; swapping a clothing item in the current outfit with one of the plurality of clothing items; or modifying a colour of a clothing item in the current outfit.

9. A computer-implemented method according to any one of the preceding claims, wherein the one or more parameters are selected from: dress code, colour palette, body colour tone classification, season, texture pattern, clothing shape, age, body proportion and body shape.

10. A computer-implemented method according to claim 9, wherein the body colour tone classification is generated by: providing a trained body colour tone classifier; receiving input data from a user relating to one or more body colour attributes; and generating, by the body colour tone classifier, a body colour tone classification from the input data.

11. A computer-implemented method according to claim 10, wherein the input data are received by obtaining user input indicating one or more locations on an image of the user; and generating colour attributes for the image at the one or more locations.

12. A computer-implemented method according to any one of claims 9 to 11, wherein the optimal or near-optimal outfit suggestion is determined based on an objective function which is a weighted sum of cost terms for the respective parameters.

13. A computer-implemented method according to any one of claims 9 to 12, wherein the dress code is selected from the group consisting of Sportswear, Casual, Business-Casual, and Business.

14. A computer-implemented method according to any one of the preceding claims, wherein the user input comprises a constraint on at least one of the clothing items.

15. A computer-implemented method according to any of claims 2 to 14 wherein a plurality of nodes of the graphical model correspond to different body regions on which a clothing item can be worn, and each node state represents the type of clothing item being worn.

16. A computer-implemented method according to any one of claims 4 to 15, comprising calculating an acceptance probability for the proposed outfit.

17. A computer-implemented method according to claim 16, comprising randomly sampling a number a from a uniform distribution on [0, 1]; and accepting the proposed outfit if a is less than or equal to the acceptance probability.

18. A computer-implemented method according to any one of the preceding claims, wherein the wardrobe data also represents a plurality of accessories, and wherein the probabilistic model further comprises probabilities of the accessories being matched with the clothing items and/or with each other conditional on the one or more parameters.

19. A computer-implemented method according to any one of the preceding claims, further comprising training the probabilistic model.

20. A system for generating an outfit suggestion, comprising:
a non-volatile storage medium having stored thereon wardrobe data representing a plurality of clothing items, and probabilistic model data representing a probabilistic model, the probabilistic model comprising probabilities of the clothing items being matched with each other conditional on one or more parameters; and
an outfit suggestion module which is configured to:
receive user input relating to at least one of the one or more parameters; and
perform an optimization to generate one or more optimal or near-optimal outfit suggestions from the wardrobe data based on the probabilistic model data and the user input.

21. A method for generating an outfit suggestion comprising the steps of:
Determining a colour classification of a user;
Providing a plurality of articles of clothing;
Selecting a dress code based on the user preference; and
Generating at least one outfit suggestion based on the colour classification of the user, the plurality of clothing items and the selected dress code.

22. The method according to claim 21, wherein determining the colour classification of a user further includes the steps of:
Providing at least one body colour attribute; and
Matching the body colour attribute with a colour palette to determine if the colour classification of the user is warm or cool.

23. A system for generating an outfit suggestion comprising:
Visual profiling means for determining the colour classification of a user;
Storage means for maintaining and updating a database of a plurality of articles of clothing;
Functional profiling means for selecting a specific dress code; and
Recommendation means for generating at least one outfit suggestion based on the results obtained from the functional profiling means and visual profiling means
